(19) United States
(12) Patent Application Publication
(10) Pub. No.: US 2019/0134992 A1
(43) Pub. Date: May 9, 2019

(54) PRINTING APPARATUS, METHOD FOR MANUFACTURING BEVERAGE USE CAN, BEVERAGE USE CAN, AND BEVERAGE CAN

(71) Applicant: SHOWA ALUMINUM CAN CORPORATION, Tokyo (JP)

(72) Inventors: Nobuhiko KIMURA, Tokyo (JP); Shinichi OJIMA, Tokyo (JP); Kazunori IKEDA, Tokyo (JP); Asumi SUWA, Tokyo (JP); Kazuhisa MASUDA, Tokyo (JP)

(73) Assignee: SHOWA ALUMINUM CAN CORPORATION, Tokyo (JP)

(21) Appl. No.: 16/096,320

(22) PCT Filed: May 23, 2017
(86) PCT No.: PCT/JP2017/019139

§ 371 Date: Oct. 25, 2018

(30) Foreign Application Priority Data
Jun. 28, 2016 (JP) 2016-127258

(51) Int. Cl. B41J 3/407; B65D 25/34; B65D 1/16

(52) U.S. Cl. CPC B41J 3/4073; B65D 1/165; B65D 25/34

(57) ABSTRACT

A joining part (connection line) (1E) between an image (1A) (image positioned on the left side of the figure relative to a wave-shaped broken line (1C) and positioned on the right side of the figure relative to the joining part (1E)) formed at the start of printing of a printed image, and an image (1B) (image positioned on the right side of the figure relative to a wave-shaped broken line (1D) and positioned on the left side of the figure relative to the joining part (1E)) formed at the end of printing of the printed image is not a straight line along an axial direction of a beverage use can (100), and a position of a part of the joining part (1E) is shifted in the circumferential direction of the beverage use can (100).

### TECHNICAL FIELD

The present invention relates to a printing apparatus, a method for manufacturing a beverage use can, a beverage use can, and a beverage can.

### BACKGROUND ART

In Patent Document 1, there is disclosed a printing device, in which inkjet printing is performed in at least one inkjet printing station, and plural inkjet heads are arranged in the inkjet printing station.

### CITATION LIST

### Patent Literature

Patent Document 1: Japanese Patent Application Laid-Open Publication No. 2012-232771

### SUMMARY OF INVENTION

### Technical Problem

A print image formed on an outer circumferential surface of a beverage can is able to be formed by use of, for example, an ink jet head. In an ink jet head, an amount of ink ejected at an ink ejection start time is larger than an amount of ink ejected at later timings in some cases; in these cases, there is a possibility that the quality of image to be formed is deteriorated.

An object of the present invention is to suppress a reduction in the quality of a printed image formed on a beverage use can due to printing by an ink jet head.

### Solution to Problem

A printing apparatus to which the present invention is applied includes: a support member that supports a beverage use can in a cylindrical shape and rotates the beverage use can in a circumferential direction; an ink jet head that includes plural ink ejection ports arranged in an axial direction of the beverage use can supported by the support member to eject ink onto an outer circumferential surface of the beverage use can rotated in the circumferential direction; and a control unit that controls ink ejection in the ink jet head, and when ink ejection to the outer circumferential surface is started, controls ink ejection so that an adhesion position where ink ejected from a first group of the ink ejection ports is adhered to the outer circumferential surface and an adhesion position where ink ejected from another group of the ink ejection ports is adhered to the outer circumferential surface are different from each other in the circumferential direction.

Here, when ink ejection onto the outer circumferential surface is started, the control unit controls ink ejection to cause the first group of the ink ejection ports to perform ink ejection before the another group of the ink ejection ports does, and, when ink ejection from an intermediate group of the ink ejection ports, which is a group of the ink ejection ports positioned between the first group of the ink ejection ports and the another group of the ink ejection ports, is performed, the control unit causes the intermediate group of the ink ejection ports to perform ink ejection after ink ejection from the first group of the ink ejection ports is performed and before ink ejection from the another group of the ink ejection ports is performed.

Moreover, when ink ejection from the intermediate group of the ink ejection ports is performed, the control unit performs ink ejection from ink ejection ports, of ink ejection ports included in the intermediate group of the ink ejection ports, positioned closer to the first group of the ink ejection ports first, and thereafter, performs ink ejection from ink ejection ports, of the ink ejection ports included in the intermediate group of the ink ejection ports, closer to the another group of the ink ejection ports.

Moreover, when printing onto the beverage use can by the ink jet head is performed, the beverage use can is rotated to be in a peripheral speed of the beverage use can from 10 m/minute to 73 m/minute.

Moreover, when the present invention is grasped as a method for manufacturing a beverage use can, the method for manufacturing a beverage use can to which the present invention is applied, and which ejects ink from plural ink ejection ports arranged along an axial direction of a beverage use can to form an image onto an outer circumferential surface of the beverage use can to manufacture a beverage use can on which the image is formed, includes: when ink ejection onto the outer circumferential surface is started, shifting an ejection timing of ejecting ink from a first group of the ink ejection ports from an ejection timing of ejecting ink from another group of the ink ejection ports, which is different from the first group of the ink ejection ports.

Moreover, when the present invention is grasped as a beverage use can, the beverage use can to which the present invention is applied includes: a can main body including an outer circumferential surface; and a printed image provided to the outer circumferential surface, the printed image being in a band shape along a circumferential direction of the can main body, wherein, of the printed image provided to the outer circumferential surface, a joining part between an image formed when printing is started and an image formed when printing is ended does not form a single straight line along an axial direction of the can main body, and a position of a part of the joining part is shifted in the circumferential direction of the can main body.

Here, at least a part of the joining part forms an oblique line inclined with respect to the axial direction of the can main body and the circumferential direction of the can main body.

Moreover, the joining part is in a wavy shape.

From another standpoint, a beverage use can to which the present invention is applied includes: a can main body including an outer circumferential surface; and a printed image provided to the outer circumferential surface, the printed image being in a band shape along a circumferential direction of the can main body, wherein, of the printed image provided to the outer circumferential surface, a joining part between an image formed when printing is started and an image formed when printing is ended does not form a single straight line along an axial direction of the can main body, and at least a part of the joining part forms an oblique line inclined with respect to the circumferential direction of the can main body and the axial direction of the can main body.

Further, when the present invention is grasped as a beverage can, the beverage can to which the present invention is applied includes: a beverage use can; and a content contained in the beverage use can, wherein the beverage use can is configured with any one of the above-described beverage use cans.

### Advantageous Effects of Invention

According to the present invention, it is possible to suppress a reduction in the quality of a printed image formed on a beverage use can due to printing by an ink jet head.

### BRIEF DESCRIPTION OF DRAWINGS

FIG. 1 is a perspective view of a beverage use can related to the exemplary embodiment;

FIG. 2 is a perspective view of a printing apparatus;

FIGS. 3A and 3B are development diagrams each showing a printed image formed on an outer circumferential surface of the beverage use can;

FIGS. 4A and 4B are development diagrams each showing a printed image formed on an outer circumferential surface of the beverage use can;

FIG. 5 is a diagram showing another example of the printed image; and

FIG. 6 is a diagram showing another configuration example of the beverage use can.

### DESCRIPTION OF EMBODIMENTS

Hereinafter, an exemplary embodiment according to the present invention will be described in detail with reference to attached drawings.

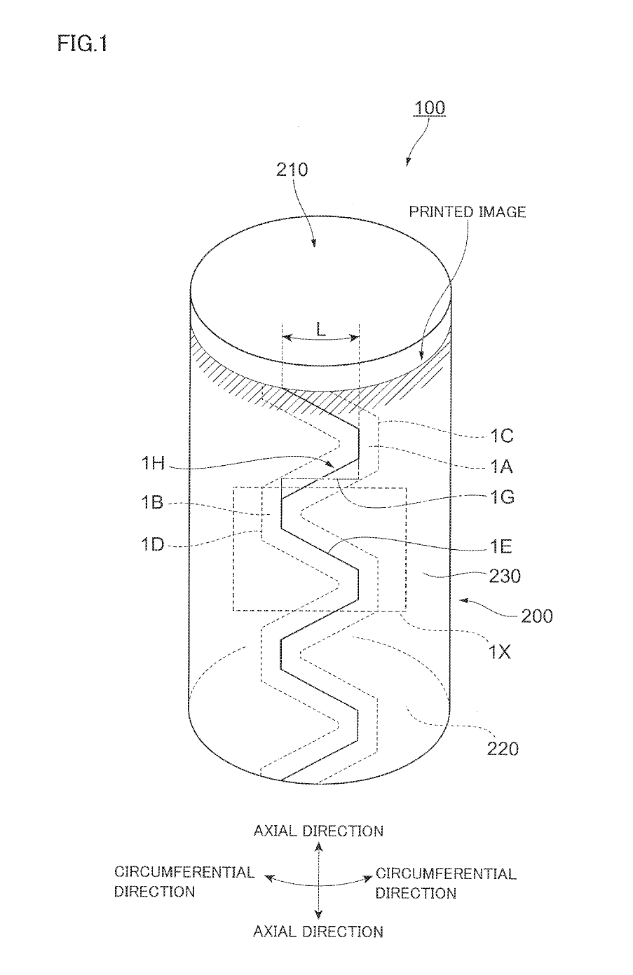

FIG. 1 is a perspective view of a beverage use can 100 related to the exemplary embodiment.

Here, in FIG. 1, illustration of details in shape of the beverage use can 100 is omitted, and the beverage use can 100 is illustrated as a bottomed cylinder. More specifically, in general, the beverage use can 100 is provided with a flange portion and a neck portion, and in general, a bottom of the beverage use can 100 is provided with a circular concave portion concaved in an inward direction of the beverage use can 100; however, illustration thereof is omitted.

The beverage use can 100 of the exemplary embodiment is provided with a can main body 200 that is formed cylindrically.

At an upper portion of the can main body 200, a circular opening 210 is formed. Moreover, at a lower portion of the can main body 200, a bottom portion 220 is provided. Moreover, the can main body 200 includes an outer circumferential surface 230.

On the outer circumferential surface 230, printing by the ink jet head is performed, and the outer circumferential surface 230 is provided with a printed image formed into a band shape along the circumferential direction of the can main body 200.

In the exemplary embodiment, inside the can main body 200 is filled with a beverage, which is the contents, through the opening 210 positioned at the upper portion of the can main body 200. Thereafter, the opening 210 is closed by a can lid that is not shown. Consequently, a beverage can filled with a beverage is completed.

The can main body 200 is formed of a metallic material. Specifically, the can main body 200 is formed of, for example, aluminum, aluminum alloy or the like. Moreover, the can main body 200 is formed of, for example, an iron alloy, such as tin-free steel, or the like.

Moreover, the can main body 200 is formed, for example, by performing drawing and ironing (DI) molding or stretching and drawing molding on a plate material in a flat plate shape.

As a beverage to be packaged inside the can main body 200, for example, an alcoholic beverage, such as beer, or a non-alcoholic beverage, such as a soft drink, can be provided.

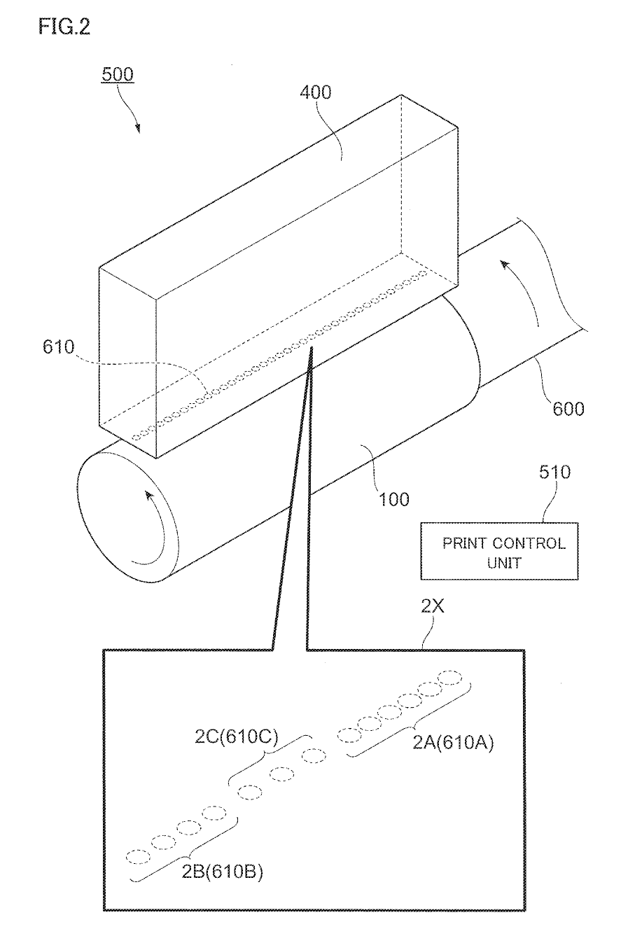

FIG. 2 is a perspective view of a printing apparatus 500.

The printing apparatus 500 of the exemplary embodiment is provided with a cylindrical-shaped support member (mandrel) 600 that is inserted into the beverage use can 100 to support the beverage use can 100.

The support member 600 is formed into the cylindrical shape and inserted into the inside of the beverage use can 100 from the opening 210 (refer to FIG. 1) of the beverage use can 100. Then, in the exemplary embodiment, by a not-shown driving mechanism, the support member 600 is rotated in the circumferential direction, and in accordance with this, the beverage use can 100 is also rotated in the circumferential direction.

Above the beverage use can 100, an ink jet head 400 is provided. At a bottom portion of the ink jet head 400, there are provided plural ink ejection ports 610 arranged along an axial direction of the beverage use can 100 supported by the support member 600.

Further, the printing apparatus 500 is provided with a print control unit 510 that controls ejection of ink in the ink jet head 400. The print control unit 510 is composed of a program-controlled CPU (Central Processing Unit). Here, the reference sign 2X in FIG. 2 shows an enlarged view of the ink ejection ports 610 used for printing of a portion indicated by the reference sign 1X in FIG. 1.

In the exemplary embodiment, the ink jet head 400 is controlled by the print control unit 510, and thereby, from the ink ejection ports 610, ink is ejected toward an outer circumferential surface of the beverage use can 100 that is positioned below and rotated in the circumferential direction. Consequently, a printed image is formed on the outer circumferential surface of the beverage use can 100.

Here, FIG. 2 is an example of printing by a single-color ink jet head 400, and printing is sequentially performed according to the similar printing method by the ink jet heads 400 of required colors, to thereby form a final image. More specifically, for example, the ink jet heads 400 of four colors of CMYK are prepared, and printing is sequentially performed according to the similar printing method by the ink jet heads 400 of respective colors, to thereby form the final image. Here, printing is performed in the order of, for example, cyan (C), magenta (M), yellow (Y) and black (K).

Note that, when printing onto the beverage use can 100 by the ink jet head 400 is performed, it is preferable to set a peripheral speed of the beverage use can 100 to 10 m/minute to 73 m/minute (10 m/minute peripheral speed 73 m/minute).

If the peripheral speed is lower than 10 m/minute, the productivity is deteriorated. Moreover, if the peripheral speed exceeds 73 m/minute, ink ejection from the ink jet head 400 is not enough, and thereby intervals between dots constituting the printed image are extended. Moreover, if the peripheral speed exceeds 73 m/minute, there is a possibility that air currents are generated between the ink jet head 400 and the beverage use can 100 and thereby adhering positions of ink are shifted.

Note that a more preferable range of the peripheral speed of the beverage use can 100 is 25 m/minute to 60 m/minute. In this case, it becomes easier to suppress deterioration of the productivity and deterioration of the image quality simultaneously.

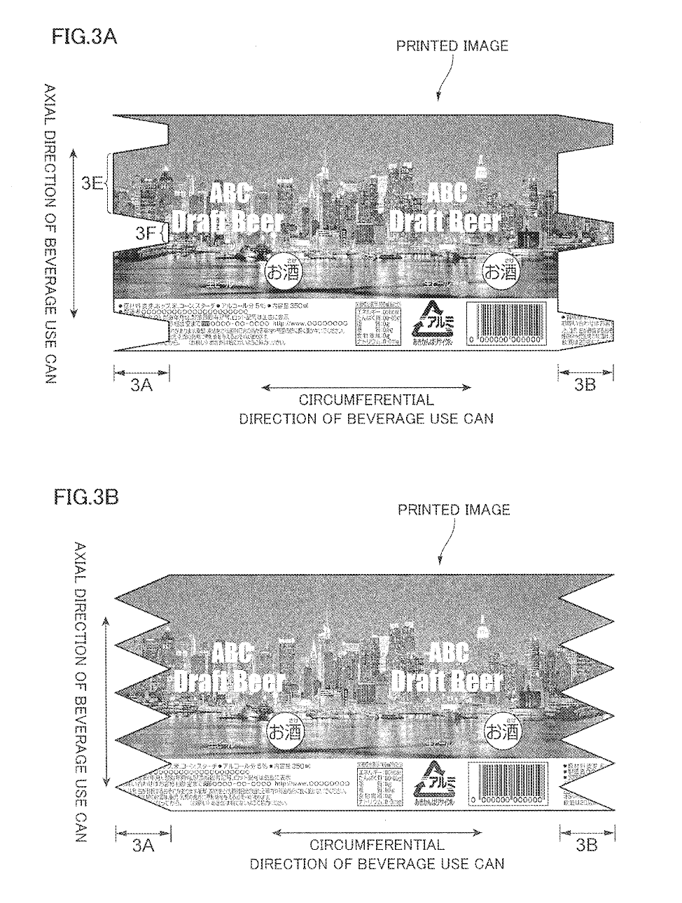

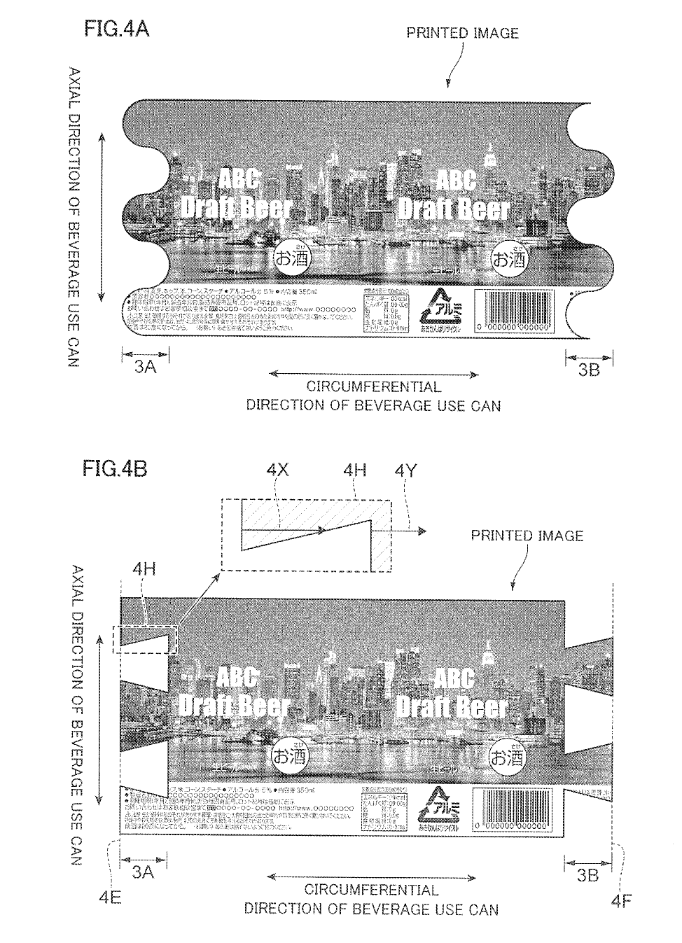

FIGS. 3A and 3B and FIGS. 4A and 4B are development diagrams each showing a printed image formed on the outer circumferential surface 230 of the beverage use can 100.

In the exemplary embodiment, as described above, the printed image is formed by the so-called ink jet printing. The printed image extends in the circumferential direction of the beverage use can 100 to be formed into a band shape.

Specifically, in the printing onto the beverage use can 100, while the beverage use can 100 is rotated in the circumferential direction, the ink is ejected from the ink jet head 400 extending along the axial direction of the beverage use can 100 toward the outer circumferential surface 230 of the beverage use can 100. Consequently, a printed image extending along the circumferential direction of the beverage use can 100 is formed on the outer circumferential surface 230 of the beverage use can 100.

In the printed image shown in FIG. 3A, the portion indicated by the reference sign 3A serves as a print start location. When printing is performed, ink ejection is started at the print start location (hereinafter, referred to as “print start location 3A”) to sequentially perform printing toward the right direction in FIG. 3A. Then, at a print finish location 3B, ejection of ink is stopped to finish printing.

Here, in printing using the ink jet head 400, the ink ejection amount at the start of printing is likely to be larger than the ink ejection amount after the printing is started, and therefore, there is a possibility that the image formed at the start of printing becomes more conspicuous than images of other portions.

More specifically, a dot image formed at the start of printing becomes larger than a dot image formed thereafter; therefore, there is a possibility that the image formed at the start of printing becomes more conspicuous.

In particular, as in the exemplary embodiment, when the beverage use can 100 is disposed and ink is simultaneously ejected from the ejection ports of the required parts on a single straight start line along the axial direction, there is a possibility that the image formed at the start of printing becomes an image with vertical streaks, and the image with the vertical streaks is likely to be more conspicuous.

Therefore, in the exemplary embodiment, when ink ejection onto the outer circumferential surface 230 of the beverage use can 100 is started, ink ejection timings are partially shifted, to thereby suppress conspicuity of images formed by ink ejected at the start of printing.

Specifically, in the printing apparatus 500 of the exemplary embodiment, when ink ejection onto the outer circumferential surface 230 is started, an ejection timing of ejecting ink from ink ejection ports 610 of a first group and an ejection timing of ejecting ink from ink ejection ports 610 of another group, which are different from the ink ejection ports 610 of the first group, are shifted.

More specifically, in the exemplary embodiment, when ink ejection onto the outer circumferential surface 230 of the beverage use can 100 is started, for example, ink ejection from the ink ejection port 610 indicated by the reference sign 2A in FIG. 2 (the ink ejection ports 610 of the first group) is performed first, and subsequently, after the reference sign 2C to be described later, ink ejection from the ink ejection ports 610 indicated by the reference sign 2B in FIG. 2 (the ink ejection ports 610 of another group) is performed.

Consequently, in the exemplary embodiment, as indicated by the reference signs 3E and 3F in FIG. 3A, two linear images formed at the start of printing are shifted in the circumferential direction of the beverage use can 100.

More specifically, in the exemplary embodiment, ink ejection from the ink ejection ports 610 indicated by the reference sign 2A in FIG. 2 (hereinafter, referred to as “earlier group of ink ejection ports 610A”) is performed first, and subsequently, ink ejection from the ink ejection ports 610 indicated by the reference sign 2B in FIG. 2 (hereinafter, “later group of ink ejection ports 610B”) is performed (after the reference sign 2C to be described later, ink ejection from the later group of ink ejection ports 610B is performed), and accordingly, as indicated by the reference signs 3E and 3F in FIG. 3A, positions of the two linear images formed at the start of printing are shifted in the circumferential direction of the beverage use can 100.

To put in another way, in the exemplary embodiment, when ink ejection to the outer circumferential surface 230 is started, ink ejection is controlled so that adhesion positions where the ink ejected from the first group of ink ejection ports 610 (the earlier group of ink ejection ports 610A) is adhered to the outer circumferential surface 230 and adhesion positions where the ink ejected from another group of ink ejection ports 610 (the later group of ink ejection ports 610B) is adhered to the outer circumferential surface 230 are different from each other in the circumferential direction of the beverage use can 100.

To describe further, in the exemplary embodiment, after ejecting ink from each of the ink ejection ports 610 included in the first group of ink ejection ports 610 (earlier group of ink ejection ports 610A) at the same timing, ink is ejected from each of the ink ejection ports 610 included in the another group of ink ejection ports 610 (later group of ink ejection ports 610B) at the same timing.

Consequently, the linear image indicated by the reference sign 3E in FIG. 3A is first formed, and subsequently, the linear image indicated by the reference sign 3F in FIG. 3A is formed (after formation of an image connecting the reference signs 3E and 3F by the reference sign 2C in FIG. 2, which will be described later, the linear image indicated by the reference sign 3F is formed), and thereby, the positions of the two linear images are shifted in the circumferential direction of the beverage use can 100.

In this case, large-diameter dots are prevented from being linearly aligned along the axial direction of the beverage use can 100, and therefore, the image formed by the ink ejected at the start of printing becomes less conspicuous.

To describe with reference to FIG. 1, a joining part (connection line) 1E between an image 1A (image positioned on the left side of the figure relative to a wave-shaped broken line 1C and positioned on the right side of the figure relative to the joining part 1E) (hereinafter, referred to as “image 1A formed at start of printing”) formed at the start of printing of a printed image, and an image 1B (image positioned on the right side of the figure relative to a wave-shaped broken line 1D and positioned on the left side of the figure relative to the joining part 1E) (hereinafter, referred to as “image 1B formed at end of printing”) formed at the end of printing of the printed image is not a single straight line along an axial direction of the beverage use can 100, and the position of a part of the joining part 1E is shifted in the circumferential direction of the beverage use can 100.

More specifically, in the exemplary embodiment, the joining part 1E is in a wavy shape (the joining part 1E is in a shape in which convex shapes (convex portions) and concave shapes (concave portions) are alternately arranged in the axial direction of the can main body 200), and at plural locations of the joining part 1E, the joining part 1E is partially shifted in the circumferential direction of the beverage use can 100.

Then, in this case, as compared to a case in which the joining part 1E forms a single straight line along the axial direction of the beverage use can 100, the joining part 1E becomes less conspicuous.

To describe further, in the print start location 3A and the print end location 3B shown in FIG. 3A, ink is ejected from the ejection ports at positions corresponding to images, and ink is not ejected from the ejection ports corresponding to regions where no image exists (blank regions positioned in each of the print start location 3A and the print end location 3B) to perform printing of the print start location 3A and the print end location 3B, and, in the locations other than the print start location 3A and the print end location 3B, printing is performed by ejecting ink from the ejection ports corresponding to the printed image, to thereby prevent the joining part (connection line) 1E in FIG. 1 from forming a single straight line along the axial direction of the beverage use can 100.

Further, in the exemplary embodiment, as indicated by the reference sign 1H in FIG. 1, part of the joining part 1E is inclined with respect to the axial direction and the circumferential direction of the beverage use can 100 to form an oblique line.

Here, for example, as indicated by the broken line 1G in the figure, it is possible to align a part of the joining part 1E with the circumferential direction of the beverage use can 100; however, in this case, an image with horizontal streaks is more likely to appear in the printed image. By adopting the oblique line as in the exemplary embodiment, it is possible to suppress occurrence of the image with the horizontal streaks.

Note that the oblique line is formed by ejecting ink from the plural ink ejection ports 610 indicated by the reference sign 2C in FIG. 2.

Specifically, the oblique line is formed by ejecting ink from the plural ink ejection ports 610 (hereinafter, referred to as “intermediate group of ink ejection ports 610C”) positioned between the earlier group of ink ejection ports 610A and the later group of ink ejection ports 610B.

More specifically, the oblique line is formed by ejecting ink from the intermediate group of ink ejection ports 610C after the ink is ejected from the earlier group of ink ejection ports 610A and before the ink is ejected from the later group of ink ejection ports 610B.

Even more specifically, when the ink is ejected from the intermediate group of ink ejection ports 610C, ink ejection from the ink ejection ports 610, of those included in the intermediate group of ink ejection ports 610C, positioned closer to the earlier group of ink ejection ports 610A is performed first, and thereafter, ink ejection from the ink ejection ports 610 closer to the later group of ink ejection ports 610B is performed.

To describe further, when the ink is ejected from the intermediate group of ink ejection ports 610C, ink ejection is sequentially performed from the ink ejection port 610, of those included in the intermediate group of ink ejection ports 610C, positioned closer to the earlier group of ink ejection ports 610A, and finally, ink ejection from the ink ejection port 610 positioned closer to the later group of ink ejection ports 610B is performed.

Consequently, as described above, a part of the joining part 1E forms the oblique line.

Note that the printed image formed on the outer circumferential surface 230 of the beverage use can 100 is formed based on image data prepared in advance. More specifically, image data including the above-described joining part 1E in the wavy shape is created by use of computer software, and based on the created image data, the printed image is formed.

More specifically, the image data including the joining part 1E in the wavy shape is created by, for example, cutting a part of image data of the portion corresponding to the print start location 3A (refer to FIG. 3A) and pasting the cut image data next to image data of the portion corresponding to the print end location 3B (refer to FIG. 3A).

In other words, part of the image data corresponding to the printed image formed at the start of printing is moved in parallel to a position next to the image data corresponding to the printed image formed at the end of printing and pasted thereto, to create new image data to be used in printing.

Then, the newly created image data is supplied to the print control unit 510 provided to the printing apparatus 500 (refer to FIG. 2). The print control unit 510 performs predetermined print processing to the image data. Specifically, color separation processing is performed, and subsequently, density adjustment for each color is performed.

Then, based on the image data after being subjected to the color separation processing and the density adjustment, the print control unit 510 controls the ink jet head 400 to form the printed image onto the outer circumferential surface 230 of the beverage use can 100.

Here, when, in the beverage use can 100, the diameter is 35 mm to 80 mm and the height (the length in the axial direction) is 60 mm to 180 mm, it is preferable to set the length L of the joining part 1E (refer to FIG. 1) (the length of the joining part 1E when the joining part 1E is projected in the axial direction of the beverage use can 100 (the length in the circumferential direction of the beverage use can 100)) to 5 mm to 30 mm. In this case, processing of an image when the image data is newly formed as described above can be performed with ease, and the printed image is less affected.

Moreover, if the joining part 1E is formed into the wavy shape, in performing printing, it is necessary to rotate the beverage use can 100 more than one revolution; however, if the length L of the joining part 1E is set to 5 mm to 30 mm, a rotation amount exceeding one revolution is small. Note that the more preferable length L of the joining part 1E is 8 mm to 25 mm.

Note that the smaller the diameter of the beverage use can 100, the smaller the circumferential length of the beverage use can 100, and thereby the proportion of the joining part 1E is relatively increased; accordingly, when the diameter of the beverage use can 100 is small, it is preferable to adopt a smaller value from the range of the length L 5 mm to 30 mm.

Moreover, in the exemplary embodiment, as described above, a part of the image data corresponding to the printed image formed at the start of printing is cut out and pasted next to the image data corresponding to the printed image formed at the end of printing; however, the location to cut out the image data is not particularly limited.

Moreover, also the number of locations to cut out the image is not particularly limited. In the example shown in FIG. 3A, cutting out of image data is performed at three location; however, for example, any of one to fifteen locations may be adopted.

The height of a usual beverage use can 100 is 60 mm to 180 mm; in this case, for example, cutting out of image data can be performed at one to fifteen locations. More preferably, the number of locations is two to five locations.

Moreover, also the cutout shape, which is a shape to cut out the image data, is not particularly limited; the shape may be, for example, a rectangle, a triangle, a trapezoid or a semicircle.

Note that, if the cutout shape is a triangle, a trapezoid or a semicircle, the oblique line is formed in the joining part 1E as described above.

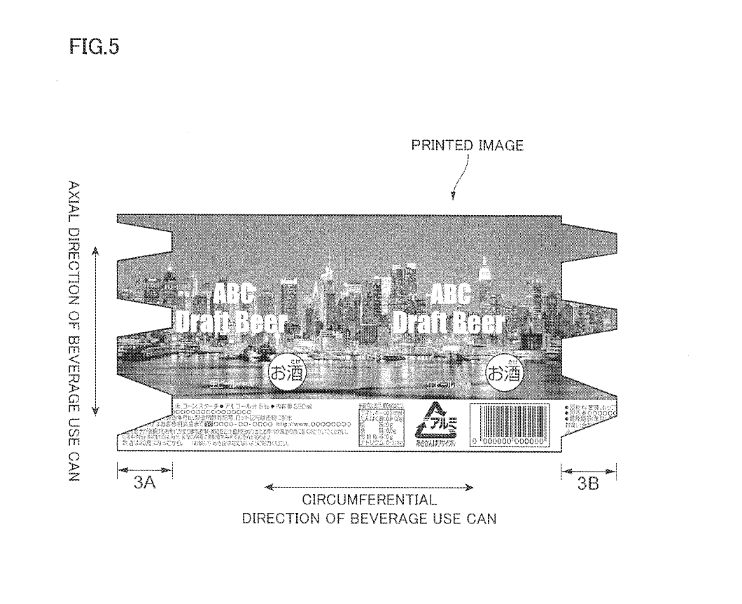

Moreover, when cutting out of the image data is performed at plural locations, the cutout shapes may be the same in the respective cutout locations, or may be different as shown in FIG. 5 (a diagram showing another example of the printed image). When the shapes are different, the wavy shape has no periodicity, and therefore, the joining part 1E becomes less conspicuous as compared to the case where the wavy shape has periodicity.

With reference to FIG. 3B and FIGS. 4A and 4B, other examples of the printed image will be described.

In the example shown in FIG. 3B, the cutout shape is a triangle. In this case, the joining part 1E is formed only by the oblique lines and does not include any straight line along the circumferential direction and the axial direction of the beverage use can 100; accordingly, the joining part 1E becomes further less conspicuous.

In the example shown in FIG. 4A, the cutout shape is a semicircle. In this case, also, the straight lines along the circumferential direction and the axial direction of the beverage use can 100 are hardly provided; accordingly, the joining part 1E becomes less conspicuous.

In the example shown in FIG. 4B, the cutout shape is a trapezoid. More specifically, a lower base with a longer side is positioned closer to a print end point indicated by the reference sign 4F and an upper base with a shorter side is positioned closer to the print start point indicated by the reference sign 4E.

In this configuration example, when printing of the location indicated by the reference sign 4H is performed, printing is performed first at the portion indicated by the reference sign 4X, and subsequently, ejection of ink is temporarily suspended, and thereafter, printing is performed again from the portion indicated by the reference sign 4Y.

In other words, in this configuration example, first ink ejection, suspension of ink ejection, and second ink ejection are performed at a specific portion. Here, in this case, similar to the above, the diameter of the dots constituting the printed image tends to become large in the second ink ejection, and accordingly, there is a possibility that the image formed by the second ink ejection becomes more conspicuous.

Therefore, it is preferable that the shape of the printed image is such that the ink ejection is not suspended along the way even in the cutout and paste image. In other words, it is preferable that intermittent operation is not performed even for a short time in the shape. In any of the examples shown in FIGS. 3A, 3B, 4A and 5, ink ejection is not suspended along the way, and ink ejection is continuously performed from the start of printing to the end of printing.

Note that, in the configuration examples shown in FIGS. 3A, 3B, 4A, 4B and 5, the lower portion of the printed image includes a white background, and further, in the lower portion, character images are formed.

When the white background is included in the printed image like this, the joining part 1E becomes less conspicuous.

Moreover, if the joining part 1E is provided to the portion in which the character images are formed, there is a fear that the character images are made illegible; however, in printing using the ink jet head 400, it is possible to perform printing with high accuracy, and therefore, the character images are prevented from becoming illegible.

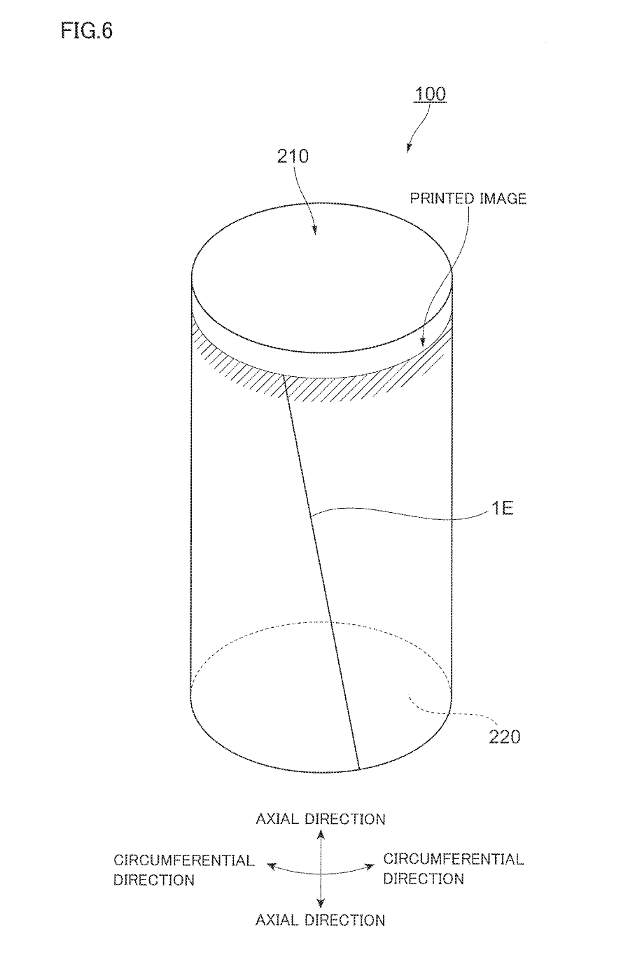

Moreover, in the above, description was given by taking the case in which a part of the joining part 1E formed the oblique line as an example; however, as shown in FIG. 6 (a diagram showing another configuration example of the beverage use can 100), all the joining part 1E may form the oblique line.

### REFERENCE SIGNS LIST

1A Image formed at start of printing
1B Image formed at end of printing
1E Joining part
100 Beverage use can
200 Can main body
230 Outer circumferential surface
400 Ink jet head
500 Printing apparatus
510 Print control unit
600 Support member
610 Ink ejection port

1-10. (canceled)

11. A printing apparatus comprising:
a support member that supports a beverage use can in a cylindrical shape and rotates the beverage use can in a circumferential direction;
an ink jet head that includes a plurality of ink ejection ports arranged in an axial direction of the beverage use can supported by the support member to eject ink onto an outer circumferential surface of the beverage use can rotated in the circumferential direction; and
a control unit that controls ink ejection in the ink jet head, and when ink ejection to the outer circumferential surface is started, controls ink ejection so that an adhesion position where ink ejected from a first group of the ink ejection ports is adhered to the outer circumferential surface and an adhesion position where ink ejected from another group of the ink ejection ports is adhered to the outer circumferential surface are different from each other in the circumferential direction.

12. The printing apparatus according to claim 11, wherein, when ink ejection onto the outer circumferential surface is started, the control unit controls ink ejection to cause the first group of the ink ejection ports to perform ink ejection before the another group of the ink ejection ports does, and, when ink ejection from an intermediate group of the ink ejection ports, which is a group of the ink ejection ports positioned between the first group of the ink ejection ports and the another group of the ink ejection ports, is performed, the control unit causes the intermediate group of the ink ejection ports to perform ink ejection after ink ejection from the first group of the ink ejection ports is performed and before ink ejection from the another group of the ink ejection ports is performed.

13. The printing apparatus according to claim 12, wherein, when ink ejection from the intermediate group of the ink ejection ports is performed, the control unit performs ink ejection from ink ejection ports, of ink ejection ports included in the intermediate group of the ink ejection ports, positioned closer to the first group of the ink ejection ports first, and thereafter, performs ink ejection from ink ejection ports, of the ink ejection ports included in the intermediate group of the ink ejection ports, closer to the another group of the ink ejection ports.

14. The printing apparatus according to claim 11, wherein, when printing onto the beverage use can by the ink jet head is performed, the beverage use can is rotated to be in a peripheral speed of the beverage use can from 10 m/minute to 73 m/minute.

15. The printing apparatus according to claim 12, wherein, when printing onto the beverage use can by the ink jet head is performed, the beverage use can is rotated to be in a peripheral speed of the beverage use can from 10 m/minute to 73 m/minute.

16. The printing apparatus according to claim 13, wherein, when printing onto the beverage use can by the ink jet head is performed, the beverage use can is rotated to be in a peripheral speed of the beverage use can from 10 m/minute to 73 m/minute.

17. A method for manufacturing a beverage use can that ejects ink from a plurality of ink ejection ports arranged along an axial direction of a beverage use can to form an image onto an outer circumferential surface of the beverage use can to manufacture a beverage use can on which the image is formed, the method comprising:
when ink ejection onto the outer circumferential surface is started, shifting an ejection timing of ejecting ink from a first group of the ink ejection ports from an ejection timing of ejecting ink from another group of the ink ejection ports, which is different from the first group of the ink ejection ports.

18. A beverage use can comprising:
a can main body including an outer circumferential surface; and a printed image provided to the outer circumferential surface, the printed image being in a band shape along a circumferential direction of the can main body, wherein,
of the printed image provided to the outer circumferential surface, a joining part between an image formed when printing is started and an image formed when printing is ended does not form a single straight line along an axial direction of the can main body, and a position of a part of the joining part is shifted in the circumferential direction of the can main body.

19. The beverage use can according to claim 18, wherein at least a part of the joining part forms an oblique line inclined with respect to the axial direction of the can main body and the circumferential direction of the can main body.

20. The beverage use can according to claim 18, wherein the joining part is in a wavy shape.

21. A beverage use can comprising:
a can main body including an outer circumferential surface; and a printed image provided to the outer circumferential surface, the printed image being in a band shape along a circumferential direction of the can main body, wherein,
of the printed image provided to the outer circumferential surface, a joining part between an image formed when printing is started and an image formed when printing is ended does not form a single straight line along an axial direction of the can main body, and at least a part of the joining part forms an oblique line inclined with respect to the circumferential direction of the can main body and the axial direction of the can main body.

22. A beverage can comprising:
a beverage use can; and
a content contained in the beverage use can, wherein
the beverage use can is configured with the beverage use can according to claim 18.

23. A beverage can comprising:
a beverage use can; and
a content contained in the beverage use can, wherein
the beverage use can is configured with the beverage use can according to claim 19.

24. A beverage can comprising:
a beverage use can; and
a content contained in the beverage use can, wherein
the beverage use can is configured with the beverage use can according to claim 20.

25. A beverage can comprising:
a beverage use can; and
a content contained in the beverage use can, wherein
the beverage use can is configured with the beverage use can according to claim 21.
